(19) United States
(12) Patent Application Publication
(10) Pub. No.: US 2014/0351034 A1
(43) Pub. Date: Nov. 27, 2014

(54) DIRECT ETAILING

(71) Applicant: NEWS AMERICA MARKETING PROPERTIES, LLC, New York, NY (US)

(72) Inventor: Henri Lellouche, Fairfield, CT (US)

(73) Assignee: News America Marketing Properties, LLC, New York, NY (US)

(21) Appl. No.: 13/901,163

(22) Filed: May 23, 2013

(51) Int. Cl. G06Q 30/02

(52) U.S. Cl. CPC G06Q 30/0222
USPC 705/14.23

(57) ABSTRACT

System, method and program product, the method comprising: receiving an entity agreement to fulfill a product or a service; providing scan indicator image information; receiving and storing image information relating to a product or service image; providing a software application to a plurality of consumers to initiate picture function and to transmit image information; receiving on the server the transmitted image information; comparing the transmitted image information to portions of the stored image information; when a match, then: retrieving the data for entity agreeing to fulfill the product or service; serving price data for the product or service corresponding to the image match, wherein the price data is net of the advertised discount; receiving a purchase selection; requesting fulfillment of the selected product or service; initiating a payment process.

### FIELD OF THE INVENTION

The present invention relates to advertised discount-driven merchant/etailer operations and to direct e-tailing.

### SUMMARY

An embodiment of a method consistent with the present invention comprises: receiving or obtaining or having received or obtained, into one or more databases by one or more computers, for each of a plurality of entities, respective agreement data for the respective entity indicating agreement to fulfill or have fulfilled a respective product or a service at a price based at least in part on an advertised discount; for each of the plurality of the entities, providing scan indicator image information to or for the entity by one or more computers, for display on the product or a service and/or on the advertised discount and/or an advertisement, and/or on a display, and/or on a page of an electronic document; receiving and storing, into the one or more databases by one or more computers, image information from their product or service or from their advertised discount or from their advertisement or from their display or from one or more pages of their electronic document; providing or facilitating provision, by the one or more computers, a software application to a plurality of consumers, with the software application configured to initiate upon activation a scanning or picture function and to transmit via one or more networks, resulting image information illustrating all or a portion of one of the products or services or one of the advertised discounts or one of the advertisements or a display or one of the electronic documents, to a server configured by the one or more computers; receiving on the server, from one of the consumers, the transmitted image information and consumer identification data; identifying the consumer, by the one or more computers, by comparing the identification data of the consumer to consumer identification data in the one or more databases; comparing, by the one or more computers, the transmitted image information to one or more portions of the stored image information to determine if there is an image match; when there is a match to one or more portions of the scanned image information in the one or more databases, then: retrieving, by the one or more computers, data for the respective entity agreeing to fulfill the product or service corresponding to the image match at the price based at least in part on the advertised discount; serving, by the one or more computers, price data for the respective product or service corresponding to the image match, wherein the price data comprises a price for the respective product or service net of the advertised discount; receiving, at the server, a selection or indication to purchase the respective product or service; requesting to the entity, by the one or more computers, to perform fulfillment of the selected product or service to the consumer; retrieving, by the one or more computers, payment data associated with the consumer from the one or more databases; and initiating, by the one or more computers, a payment process to the entity at the price based at least in part on the advertised discount.

In embodiments, the method may further comprise causing, by the one or more computers, transfer of funds to the entity for fulfillment of the respective product or service.

In embodiments, the requesting fulfillment step may further comprise providing a consumer fulfillment address and a transfer of funds to the respective entity in the request.

In embodiments, the serving step may further comprise serving an identification of and a price for at least one other product or service related to the product or service selected.

In embodiments, the software application may be configured to generate display data indicating a progression in a purchase process.

In embodiments, the display data may provide a line with at least nodes labeled sign-in, payment, and receipt.

In embodiments, the software application may be configured to provide an icon or button to trigger shopping for other products or services.

In embodiments, the method may further comprise subtracting, by the one or more computers, the price from a predetermined free shipping amount to obtain a difference amount; and generating, by the one or more computers, display data indicating an additional purchase amount based on the difference amount that is needed in order to qualify for free shipping.

In embodiments, the advertised discount data may be included with the price data.

In embodiments, the method may further comprise correlating, by the one or more computers, purchase data for the product or service with one or more demographic data elements of the consumer; determining, by the one or more computers, different consumers that match one or more of the demographic elements; and communicating electronically an offer, by the one or more computers, to a different one of the consumers that match the one or more demographic elements that are the same as the consumer that purchased the respective product or service, the offer being for the same product or service or for a different product or service offering related to the respective product or service.

In embodiments, the method may further comprise categorizing products and/or services, by the one or more computers, into a cyclical category and a non-cyclical category; associating, by the one or more computers, a respective purchase cycle to each of multiple of the respective products and/or services that are categorized in the cyclical category; and communicating electronically an offer, by the one or more computers, to a consumer that has purchased a respective product or service in the past, the offer for the same product or service or for a different product or service offering related to the respective product or service, wherein the offer is communicated at a time based at least in part on the purchase cycle associated with the respective product or service.

In embodiments, the software application is configured to cause display of an indicator to link to one or more server pages showing current discount offers, and further comprising serving, by the one or more computers, one or more server pages showing the current discount offers.

In embodiments, a system is disclosed, comprising: one or more computers, with memory storing computer-readable program code to perform, when executed, the steps: receiving or obtaining or having received or obtained, into one or more databases by the one or more computers, data for an entity indicating agreement to fulfill or have fulfilled a product or a service at a price based at least in part on an advertised discount; providing scan indicator image information to or for the entity by one or more computers, for display on the product or a service and/or on the advertised discount and/or an advertisement, and/or on a display, and/or on a page of an electronic document; receiving and storing, into the one or more databases by one or more computers, image information from the product or service or from the advertised discount or from the advertisement or from a display or from one or more pages of an electronic document; providing or facilitating provision, by the one or more computers, a software application to a plurality of consumers, with the software application configured to initiate upon activation a scanning or picture function and to transmit via one or more networks, resulting image information illustrating all or a portion of the product or service or the advertised discount or of the advertisement or of an electronic document, to a server configured by the one or more computers; receiving on the server, from one of the consumers, the transmitted image information and consumer identification data; identifying the consumer, by the one or more computers, by comparing the identification data of the consumer to consumer identification data in the one or more databases; comparing, by the one or more computers, the transmitted image information to one or more portions of the stored image information to determine if there is an image match; when there is a match to one of the scanned image information in the one or more databases, then: retrieving, by the one or more computers, data for the entity agreeing to fulfill the product or service at the price based at least in part on the advertised discount; serving, by the one or more computers, price data for the product or service corresponding to the image match, wherein the price data comprises a price for the product or service net of the advertised discount; receiving, at the server, a selection or indication to purchase the product or service; requesting to the entity, by the one or more computers, to perform fulfillment of the selected product or service to the consumer; retrieving, by the one or more computers, payment data associated with the consumer from the one or more databases; and initiating, by the one or more computers, a payment process to the entity at the price based at least in part on the advertised discount.

### BRIEF DESCRIPTION OF THE DRAWINGS

FIG. 1 is a schematic block diagram representing some embodiments of the invention.

FIG. 2 is a flowchart for implementing embodiments of the invention.

FIG. 3 is a flowchart for implementing embodiments of the invention.

FIG. 4 is a flowchart for implementing embodiments of the invention.

FIG. 5 is a schematic block diagram of a system and program configuration for implementing embodiments of the invention.

FIG. 6 is a schematic block diagram of a computer configuration for implementing embodiments of the invention.

FIG. 7 is an illustration of a smart phone or PDA with an embodiment of a Deals display.

FIG. 8 is an illustration of a smart phone or PDA with an embodiment of a Scan display.

FIG. 9 is an illustration of a smart phone or PDA with an embodiment of a Sign In display.

FIG. 10 is an illustration of a smart phone or PDA with an embodiment of a Confirm display.

FIG. 11 is an illustration of a smart phone or PDA with an embodiment of a Receipt display.

FIG. 12 is an illustration of an advertisement with Buy Now With SmartSource Direct logo.

FIG. 13 is a schematic block diagram representing further embodiments of the invention.

FIGS. 14A and 14B comprise a flowchart for implementing embodiments of the invention.

FIG. 15 is an illustration of a smart phone or PDA with an embodiment of a Shop display.

### DETAILED DESCRIPTION OF EMBODIMENTS

The present invention comprises a management system, method and program product for advertised discount-driven ecommerce. Embodiments may comprise a mobile ecommerce and ecouponing platform for use in coupon-driven e-tailing. Embodiments may comprise methods for consumer interaction with the system and merchants/etailers. Embodiments may comprise system interaction with consumers and advertisers.

The following U.S. patent applications are incorporated in their entirety for all purposes: U.S. Ser. No. 13/253,590, filed Oct. 5, 2011, titled “A System and Method for Coupon Validation,” U.S. Ser. No. 13/191,044, filed Jul. 26, 2011, titled “Promotional Content and Coupon Delivery,” U.S. Ser. No. 12/704,376, filed Feb. 11, 2010, titled “Secure Coupon Distribution,” and U.S. Ser. No. 13/351,854 filed Jan. 17, 2012 titled “COUPON-DRIVEN ETAILING.” It is contemplated that implementations of embodiments of the invention may include the features disclosed in these applications, particularly the details on the server operations, the coupon code creation, security operations, coupon validity verification, etc.

In embodiments, a media or other service server may allow consumers to register one or more financial cards (credit, debit, gift, loyalty, etc.) or other account accessible electronically to a service that will allow them to select products and/or services to purchase, and may allow the consumer to select from one or more vendors and obtain an automatic crediting of a coupon amount. The service server, in embodiments, may be driven by coupons, such as free-standing inserts (FSI's—a coupon placement occurring loosely within media, e.g., such as newspapers and/or direct mail, and may or may not require the customer to cut away from other material in order to use. FSI also includes electronic FSI's, to be discussed below), or other coupons such as electronic coupons, that contain special quick response (QR) codes, bar codes, or other codes, or SMS (short messaging service) text messages or other electronic messaging that facilitates access to a network landing page for the service. Coupon offers within the scope of the invention are not limited to distribution by FSIs, but may alternatively be distributed by other means, including outdoor advertising (e.g., billboards and other signage, subways, buses, stations and commuter hubs), in-store advertising (e.g., kiosks, shelf-mounted, floor advertising, point-of-sale displays), direct mail, email, social networking sites, websites. Magazines, catalogues and the like. A QR code is a specific matrix barcode, readable by dedicated QR barcode readers. QR barcode reader software may be downloaded and run on a user/consumer device. In embodiments, the user/consumer device may be configured to scan multi-dimensional barcode images that are Quick Response (QR) codes or other codes. The user/consumer device may also be configured to send a text message via any known method, or enter a coupon code manually through a web page or other communications interface.

Accordingly, a user/consumer device may scan or otherwise enter/input a QR code or other code on in-store, outdoor or home-delivered advertising, or send a text message, to a designated network address. In return, the user/consumer device receives product/service information, coupon data, prices from the individual merchant or merchants, and/or a link to request samples.

Communications described herein may be effectuated via any combination of wired or wireless networks including, but not limited to, a mobile telephone network, a wireless Local Area Network (LAN), a Bluetooth personal area network, an Ethernet LAN, a token ring LAN, a wide area network, the Internet, etc. For exemplification, a mobile telephone network may provide connectivity of a consumer/user device with the Internet. Connectivity to the Internet may include, but is not limited to, long range wireless connections, short range wireless connections, and various wired connections including, but not limited to, telephone lines, cable lines, power lines, and the like. The consumer/user devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A consumer/user device may communicate using various media including, but not limited to, radio, infrared, laser, cable connection, and the like.

The communication may be to and from one or more system servers. Some information and/or processing may also be received from and/or performed by one or more third party servers. Embodiments of Web servers upon which the website application may be implemented may be Apache HTTP servers or some other server capable of accepting and servicing HTTP requests and responses, respectively. In embodiments, SSL may be enabled in the web servers to enforce all communication from users using HTTPS. Any number of web servers may be utilized in the system. The web servers may also contain static files, such as HTML, JavaScript, CSS, images, and any other static content of a web page. Consumers and advertisers may communicate with the web servers via the Internet. In embodiments, service administrators may communicate with the web servers via the Internet as well, e.g., from within an intranet of a third-party coupon generator/distributor. In embodiments, requests to the web servers may be routed via a firewall for security. Advertisers may also connect to one or more ftp servers for downloading D2C integration data.

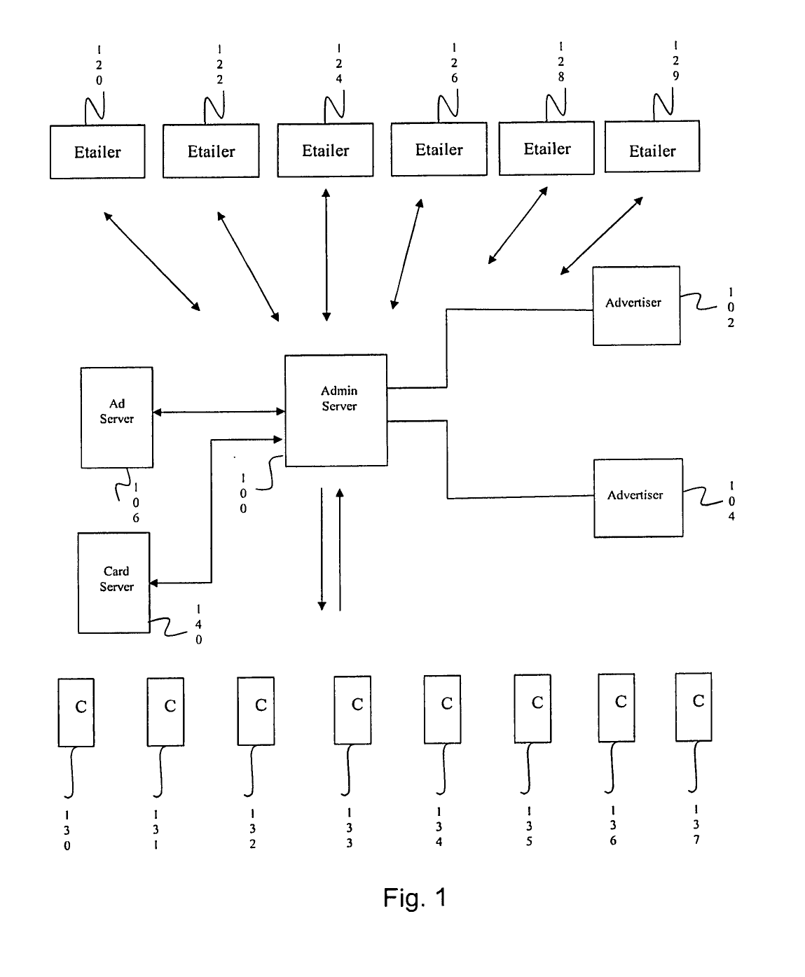

Referring to FIG. 1, there is illustrated a schematic that may used to implement various embodiments of the invention. A service server 100 for providing an ecommerce platform may communicate with a plurality of advertisers 102 and 104. Advertisers such as consumer packaged goods company and service company advertisers (CPG's) may buy advertising space in a media product and may desire to “ecommerce” enable the advertisement using the embodiments of the present invention. In embodiments, a page of the media product (e.g., print media, electronic media, etc.) may include an offer for a product and/or service, a coupon and a special media QR or other code, or a text Code. The data for the advertisement may be stored in as Ad server 106. As noted, the media product may be a print product, and/or a Web or other Internet products, etc., from which a code and/or text message may be obtained. Note that the type of media product (print media, electronic media, etc.) from which the code and/or text message may be obtained is not limiting on the invention.

In embodiments, the CPG advertiser 102, 104, may select a coupon to be associated to an advertised product and/or service and may preselect certain ecommerce partners 120-129, who may be included in an array of etailers for the respective coupon offering of the product and/or service. In embodiments, the selection of one or more of the etailers 120-129 may be based at least in part on input data from media system server or from another entity. For example, there may be a media system-approved etailer list or a better business approved etailer list from which the CPG advertiser may select. In embodiments, there may be a white list of etailers, and/or a black list of etailers. In embodiments, the selection of etailers may be made by the media system. In embodiments, the CPG advertiser may limit the ecommerce offerings for its products to its own ecommerce operation.

In embodiments, a consumer, e.g., one of the consumers 130-137, may click on an media operator code on the media system server for a first time and set up an account. In embodiments, an interactive server registration program operation with the consumer may commence to add one or more bank cards, credit cards or other account access information for payment to a data structure for the media account for the consumer. In embodiments, the payment account information may include one or more mobile communication accounts. In embodiments, the media account data structure may further include one or more physical addresses for mail or other fulfillment of the ecommerce transaction. Information such as loyalty card/account information may be provided. It should be noted that storage of such card/account information may be used to create a profile for the particular consumer, with shopping preferences, preferred etailers, where, how, or under what circumstances electronic FSI, coupons, advertisements, etc. are to be received and/or displayed to the consumer, to name a few. For example, a consumer may only wish to receive targeted promotional content that is location-based, or may only wish to receive coupons relating to a particular type of etailer product or service. The profile information may be stored locally on a consumer device, and/or at a remote profile database controlled by and/or co-located with, e.g., the coupon system. The profile information may be updated and/or modified at any time by the consumer via a standalone application or through remote access via the coupon system or other interface to the remote profile database. The profile may include data on etailer purchases and/or other purchases, and account balances, etc.

In embodiments, a consumer's subsequent purchases may then be as simple as a one-click, one-scan or one text process to execute an etailing transaction, with payment and a fulfillment address automatically provided to a merchant server from the profile information. In embodiments, it may be preferable to incorporate multiple steps in the transaction process, e.g., to avoid inadvertent transactions.

In embodiments, after an account set-up, the consumer may scan or key in or otherwise obtain a code from a coupon. A network link may be used to access a server in accordance with the present invention. The accessed server determines if the coupon code is for a live/valid offer, e.g., with a predetermined date range, etc. In embodiments, the code may be decoded. If the coupon code is for a live offer, then a mobile landing page may be accessed that comprises an array of etailers selected by either the media operator or the system and/or the CPG advertiser for inclusion in the coupon offering. Retailers such as Amazon, Walmart.com, CVS.com, Safeway.com, Diapers.com etc. may be part of the listing of vendors, among others.

In embodiments, the consumer may select one of the etailers. In embodiments, the system server 100 and/or an etailer server, e.g., 120-129, and/or another server may then open a transaction, create a transaction record, and close a sale at a retail value of the product and/or service. In some embodiments, the system server 100 may initiate fulfillment of the product and/or service to the consumer. In embodiments, the system server 100 may provide data from a transaction record created for the transaction to another server, which may be a third party fulfillment server, to perform fulfillment of the product and/or service, e.g., to generate/obtain the address for the consumer, obtain the product from a warehouse, and place the product into the mail or other delivery stream. Note that which one or more servers perform the foregoing operations is not limiting on the invention.

In embodiments, the system may initiate an automatic crediting of the value of the selected coupon associated with the product and/or service offering automatically to the consumer's bank card or loyalty card, represented for some embodiments, as the card server 140 in FIG. 1. In embodiments, this step may comprise initiating and sending or making accessible an instruction to credit the consumer's payment card or another card designated by the consumer. In some embodiments, the value of the coupon listed and associated with the offer is not automatically credited to the consumer's bank card or other consumer account until after data is received indicating that the sale transaction is closed and/or the money has been transferred. In embodiments, the crediting initiation may comprise automatically adding the credit to a transaction list, to be sent in batch to card processor. In embodiments, this crediting may give the consumer the coupon deduction without the need for retailer-advertiser involvement or with minimal involvement in the coupon processing. In embodiments, a debit may be applied to a funded redemption account of the CPG Advertiser for each manufacturer coupon redeemed, closing out the respective promotional transaction. In embodiments, the amount of the coupon may be applied at the time of the transaction as a reduction of the purchase price, similar to the typical manner of coupon redemption at a supermarket checkout. Note that embodiments of this processing may appeal to the consumer, who would normally have to place the coupon in the mail, after completing information required to redeem the coupon, and then wait for multiple months to receive the credit and/or a bank check (which would have to be cashed).

In embodiments, the system or a third party may produce a report that reflects the purchases and the coupons issued and redeemed that apply to each system transaction and may submit the report to the CPG, or allow CPG access to a network address with the report or information therefrom. In embodiments, the CPG advertiser may obtain a report or otherwise be able to monitor the purchases driven by the coupon in substantially real-time.

In embodiments, multiple offers may be listed within each FSI or magazine placement. Note that embodiments are not limited to placement in media vehicles using text codes. The coupon program may be electronically conveyed as well.

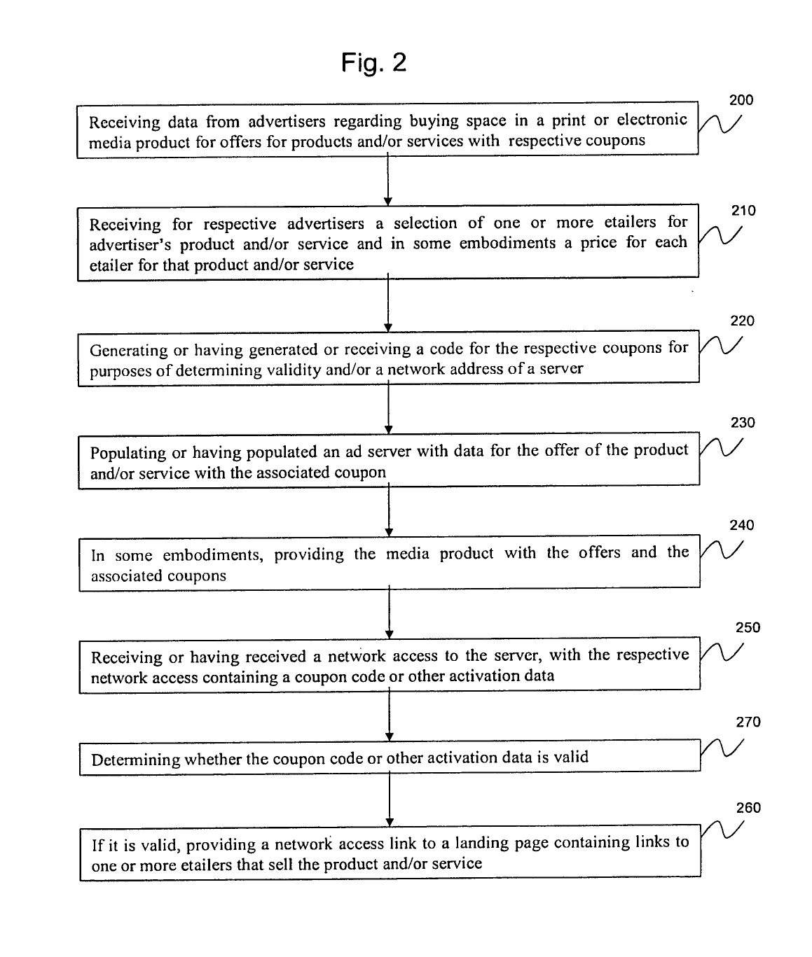

An embodiment of a method for implementing the invention is shown in FIG. 2. An operation, represented by block 200, is disclosed of receiving data from one or more advertisers regarding buying space in a print or electronic media product for offers for respective products and/or services with respective coupons.

In embodiments, an operation represented by block 210, is provided of receiving from the respective advertisers a selection of one or more etailers/merchants for making the purchase of the product and/or service. In embodiments, one of the etailers may be the advertiser itself. In embodiments, the only etailer selected may be the advertiser itself.

In some embodiments, an operation may also be provided of obtaining a respective price for the product and/or service from each of one or more of the etailers selected for the respective advertiser's product and/or service.

In embodiments, an operation represented by block 220, is provided of generating or having generated or receiving respective codes for the coupons for purposes of determining validity of the respective coupons, and/or determining a network address of a server for the coupons. In embodiments, the code may be a QR code or other code.

In embodiments, an operation represented by block 230, is provided of populating or having populated a database of offers comprising data for the respective offers for advertiser products and/or service and their respective coupons with the coupon codes being accessible by an ecommerce platform at a network location.

In some embodiments, an operation represented by block 240, is provided of providing the media product with the advertisement with the coupon with the coupon code. In embodiments, this may comprise printing or having printed on hardcopy, e.g., a newspaper, a magazine, a flyer, to name a few. In embodiments, this operation may comprise serving or having served a web page with the coupon displayed. In embodiment, this operation may be performed by a third party media operation.

In embodiments, an operation represented by block 250, is provided of receiving or having received a network access to the server, with the respective network access containing a coupon code. In embodiments, this operation may comprise receiving data from a consumer electronic device client with access to the system server 100. In embodiments, this access may be from a link in an electronic coupon displayed on a web page. In embodiments, this access may be from a consumer's PDA or cellphone, or other electronic network device. The type of device used by the consumer to access the system server is not limiting on the invention.

In embodiments, an operation represented by block 260, is provided of determining whether the coupon code received in the consumer access is a coupon code for a valid coupon. In embodiments, this operation may comprise performing or having performed a comparison of the received code to a set of valid coupon codes held in a database.

In embodiments, an operation represented by block 270, is provided of, if the coupon code is for a valid coupon, then providing a network access link to a landing page containing electronic network links to one or more etailers that sell the product and/or service. In embodiments, this landing page may also comprise a respective price for the product and/or service offered by a plurality of the selected etailers. In embodiments, this electronic network link may take the consumer directly to a transaction page for the respective etailer to execute the sale of the product and/or service. In embodiments, the electronic network link may be to a transaction page for the system to execute the sale of the product and/or service on behalf of the etailer or on its own behalf.

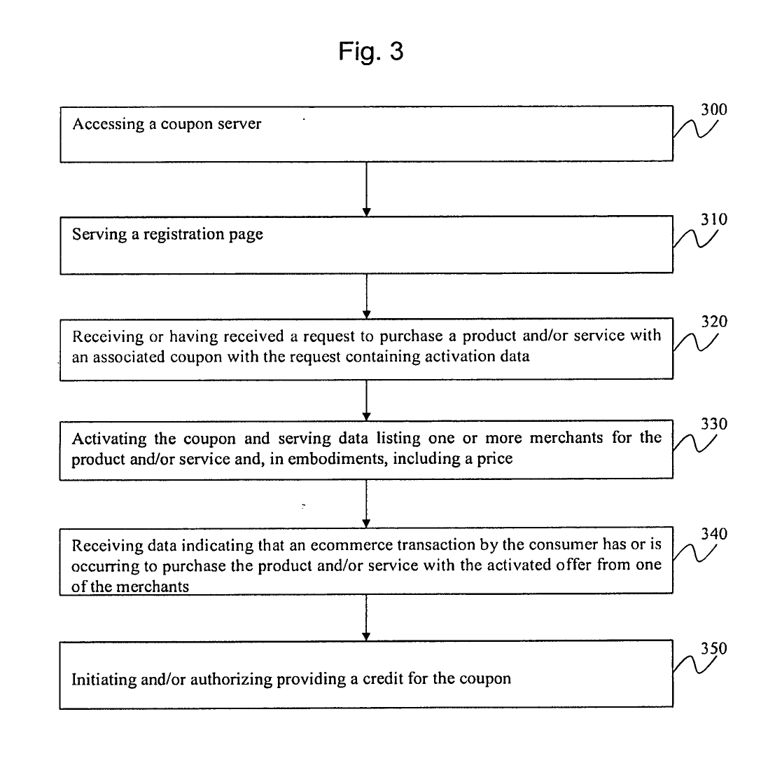

A second embodiment of a method for implementing the invention is shown in FIG. 3. An operation, represented by block 300, is provided of accessing, using one or more networks and one or more computers, a coupon server storing data on a plurality of coupons for use with media products. In embodiments, a step may be performed of maintaining or having maintained the coupon server.

In embodiments, an operation represented by block 310, is provided of serving, using one or more networks and the one or more computers, a consumer registration page to obtain a consumer fulfillment address and payment account information for the consumer, and to record a passcode for the consumer. In embodiments, this operation may comprise serving to the consumer a coupon-driven etailing registration application, with web pages for enrolling the consumer, obtaining his/her bank and/or other payment cards and/or loyalty cards, and obtaining one or more fulfillment addresses for the consumer, and registering a consumer ID and issuing or having issued to the consumer a passcode.

In embodiments, an operation represented by block 320, is provided of receiving or having received, via the one or more electronic networks and using the one or more computers, activation data activating an offer with an associated coupon for purchase of a product and/or service. In embodiments, this activation data may comprise a coupon code and/or an email or other message.

In embodiments, an operation represented by block 330, is provided of activating the coupon associated with the activation data, and serving, using the one or more computers, data listing one or more etailers/merchants for the product and/or service, with a price for the product and/or service for one or more of the etailers/merchants. In embodiments, activating the coupon may comprise associating an instance of the coupon with the consumer in the one or more databases. In embodiments, the activation of the coupon may comprise transmitting or otherwise providing a token, e.g., an alpha-numeric character string, to the consumer network device. In embodiments, there may be a plurality of etailers/merchants for the respective product and/or service, with a price for the product and/or service for each of multiple of these merchants/etailers.

In embodiments, an operation represented by block 340, is provided of receiving or having received, via the one or more electronic networks and using the one or more computers, data indicating that an ecommerce transaction for the consumer has or is occurring to purchase the product and/or service with the activated coupon for the consumer from one of the one or more etailers/merchants.

In embodiments, an operation represented by block 350, is provided of initiating and/or authorizing, using the one or more computers, provision of a credit for the coupon on the credit or debit card or loyalty card or other account designated by the consumer. In embodiments, this may comprise transmitting or posting data for the coupon credit, or simply crediting the coupon amount as a discount at the time of purchase.

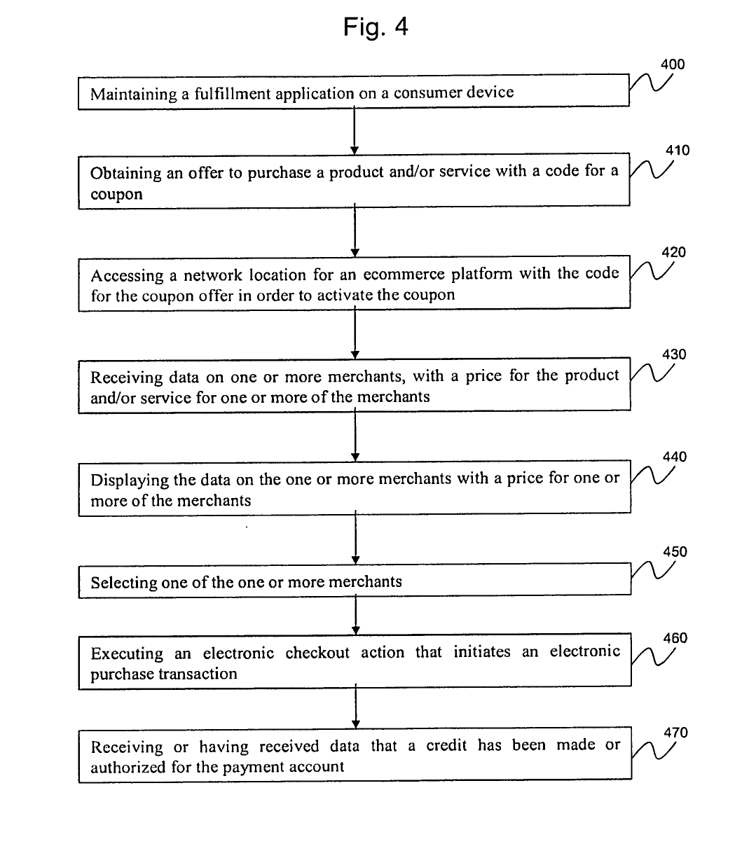

A third embodiment of a method from a consumer standpoint for implementing the invention is shown FIG. 4. An operation, represented by block 400, is provided of maintaining or having maintained, an application on one or more computers for making purchases, the application configured to access data for a fulfillment address and a payment account number, and configured with passcode security. In embodiments, the application may comprise computer software and/or a data structure, that may comprise data for ID for the consumer, a passcode for the consumer, the consumer's one or more fulfillment addresses and a payment account number. In embodiments, the application may be triggered to provide the consumer's fulfillment address and payment account number to an etailer.

In embodiments, an operation represented by block 410, is provided of obtaining an offer to purchase a product and/or service in conjunction with a code for a coupon. In embodiments, a user network device such as a cell phone or other PDA may be used to scan a QR code or other code or digital trigger or a text message from an advertisement on a medium, e.g., a newspaper, a magazine, a book, a web page, or any other medium that may contain a QR code or other code or a text message. In embodiments, the code may be obtained from an email or other network communication.

In embodiments, an operation represented by block 420, is provided of accessing a network location for an ecommerce platform with the code obtained for the coupon, using one or more networks and the one or more computers, in order to activate the coupon for the product and/or service. In embodiments, the accessing operation may be accomplished by clicking on an electronic network link to the coupon website. In embodiments, the accessing operation may be accomplished by keying or otherwise providing the network address for the coupon website to a browser program. In embodiments, as noted, the code transmitted over the one or more electronic networks to the coupon server may have been obtained by scanning a code from a coupon, and may comprise a text message transmitted over the one or more electronic networks to the coupon server.

In embodiments, an operation represented by block 430, is provided of receiving data, over the one or more electronic networks and using the one or more computers, listing one or more etailers/merchants for the product and/or service, with a price for the product and/or service for one or more of the etailers/merchants. In embodiments, this operation may comprise accessing a webpage with this data. In some embodiments, a token may be provided to the consumer network device.

In embodiments, an operation represented by block 440, is provided of displaying, using the one or more computers, the data for the one or more etailers/merchants with the price for the product and/or service for one or more of the etailers/merchants. In embodiments, there may be multiple etailer/merchants and a price for the product and/or service may be displayed for multiple of these etailers/merchants.

In embodiments, an operation represented by block 450, is provided of selecting, using the one or more computers, a one of the one or more etailers/merchants for the purchase of the product and/or service. In embodiments, the selecting may comprise clicking a button or other selection device on a web page displayed to the consumer. In some embodiments, a token may be appended to the access.

In embodiments, an operation represented by block 460, is provided of executing, using the one or more electronic networks and the one or more computers, an electronic checkout action that initiates: opening an ecommerce purchase transaction at the selected etailer/merchant, providing the fulfillment address and a payment account number for paying for the product and/or service. In some embodiments, a token may be provided to the selected etailer/merchant server.

In embodiments, an operation represented by block 470, is provided of receiving or having received at or after conclusion of the purchase transaction, using the one or more computers, data indicating that a credit for the coupon has been received and/or authorized. In embodiments, when data is received indicating that the transaction is closed, the coupon savings may be credited for the purchase to the bank card or loyalty card or other payment mechanism used for the transaction or to an account designated by the consumer or the etailer/merchant or the system. In embodiments, purchases of a plurality of different products and/or services may be made in one on-line session or transaction, with a different respective coupon associated with each of multiple of these different purchases. At checkout, the system may credit coupon savings for these multiple different purchases to one or more payment cards.

In embodiments, the consumer may select multiple coupon offers associated with a “basket” of products in a single transaction or on-line purchase session. In embodiments where the associated products may be purchased from multiple merchants, the system may be configured to automatically calculate the lowest total cost for the basket of products from a single merchant from among the plurality of merchants/etailers, taking into account the respective advertised discounts, as well as shipping, taxes, and any other applicable charges. In embodiments, the system may be configured to calculate the lowest total cost for the basket of products from more than one merchant, taking into account the respective advertised discounts, as well as shipping, taxes, and any other separate transaction charges associated with each merchant. In embodiments, the one or more calculated total prices for the “basket” of products may then be displayed to the user. Note that in addition to the basket of product and/or services with respective associated coupons, other products and/or services may be included in the purchase that do not have an associated coupon.

In embodiments, further steps may be performed of downloading, using the one or more computers, the application onto the one or more computers, storing data for one or more credit cards and/or debit cards and/or loyalty cards to the application, and storing one or more physical addresses for fulfillment by a fulfillment entity.

In embodiments, further steps may be performed of adding, using the one or more computers, multiple product and/or services to an electronic shopping cart, multiple of the products and/or service having respective coupon associated therewith to the electronic shopping cart, wherein the executing a checkout action is performed for the multiple products and/or services in the electronic shopping cart.

The invention in a further embodiment is implemented in a system, comprising one or more computers, comprising memory storing computer-readable instructions for an application for making purchases, the application configured to access data for a fulfillment address and a payment account number, and in embodiments, may be configured with passcode security. The application configuring the one or more computers may comprise computer code to scan or otherwise obtain, using the one or more computers, a coupon code associated with an offer to purchase a product and/or service. In embodiments, this scanning may trigger automatically, or in response to clicking an activation button or other designator, initiate an electronic action, using one or more electronic networks and the one or more computers, to activate the offer for the product or service, having an associated coupon. As noted, in embodiments this operation may comprise browsing to an ecommerce network location.

In embodiments, the application configuring the one or more computers may comprise computer code to receive, over the one or more electronic networks and using the one or more computers, data from a server listing one or more etailers for the product and/or service. In some embodiments, a price for the product and/or service for each of the one or more etailers for the product and/or service may be listed.

In embodiments, the application configuring the one or more computers may comprise computer code to display on a screen, using the one or more computers, the data for the one or more etailers with the price for the product and/or service for each of the plurality of the etailers.

In embodiments, the application configuring the one or more computers may comprise computer code to display a selection facility to select, using the one or more computers, a preferred or mandated etailer for purchase of the product and/or service;

In embodiments, the application configuring the one or more computers may comprise computer code to execute, using the one or more electronic networks and the one or more computers, an electronic checkout action that initiates: opening an ecommerce transaction at the selected etailer, providing the consumer's fulfillment address, and initiating provision of the payment account number for paying for the product and/or service.

In embodiments, the application configuring the one or more computers may comprise computer code to receive data indicating that a credit for the coupon has been received and/or authorized for the payment account number.

Embodiments for presentation of coupons are now described. In accordance with some embodiments, an application may be provided at a consumer/user network device, such as one of the aforementioned portable and/or wireless electronic devices, for receiving one or more coupons, advertisements, electronic FSIs, or other instances of promotional content, generated by a coupon system. The application may be a standalone application that is downloaded to or otherwise made available on the consumer device, e.g., by pre-loading the application during manufacture and/or configuration of the consumer device. Depending on the operating system or platform utilized by the consumer device, the application may be developed and/or adapted accordingly. For example, the standalone application may be developed using iOS SDK for the iPad™ or iPhone® platform. Java 2 Platform, Micro Edition (J2ME), as well as device-specific application programming interfaces (APIs) may be utilized to implement the standalone application for other devices. Additionally, U.S. Pat. Nos. 7,663,607 and 6,157,363 disclose systems and methods of controlling, e.g., touchscreen devices, as well as displaying data records, each of which is incorporated herein by reference. It should be noted that such implementations are merely exemplary, and any other known or future development tools may be utilized to effectuate various embodiments.

In embodiments, promotional content may be embedded or included within a document, such as an ePub document or other visual or readable document. For example, an ePub document is a type of document created using an open e-book standard promulgated by the International Digital Publishing Forum designed for reflowable content, where text display can be optimized for a particular consumer device's display. Thus, instead of an ePub document merely containing the textual content of, e.g., a book or publication, the ePub document in accordance with various embodiments may also include one or more coupons, advertisements, etc. That is, at the end of each chapter of an ePub document or at a desired section of a digital newspaper, one or more coupons may be displayed to a consumer similar to the manner in which FSIs are included within paper publications such as, e.g., conventional newspapers or magazines. Further still, an electronic FSI may be implemented as its own ePub document. If the consumer device has the capability to access a data network such as the Internet, the one or more coupons included in an electronic FSI, for example, may provide/include one or more links or pointers to, e.g., an advertiser's webpage, a retailer's webpage, a partner microsite, etc., associated with the one or more coupons.

It should be noted that in addition to the aforementioned implementations, various embodiments may be realized through interaction between embedded content and a standalone application. That is, promotional content, such as coupons, advertisements, or electronic FSIs embedded in a document, such as an ePub document, may trigger a standalone application to be executed. For example, when a consumer/user comes upon embedded promotional content within an ePub document, the standalone application may be automatically executed to effectuate an interactive experience.

A standalone application may be used in conjunction with the coupon system to distribute and display one or more coupons, promotional content, etc. That is, such an application may be configured to determine when a consumer is utilizing, e.g., the iBooks™ application of an iPad™, so that when a consumer enters the Apple® online Store or a physical Apple store, an electronic FSI may be displayed to the consumer. In embodiments, the electronic FSI may be associated with the purchase of e-books or other products/services, as desired. In embodiments, a standalone application may determine that the consumer has accessed a web browser, whereupon the standalone application accesses the coupon system to retrieve offers, or the standalone application is otherwise provided with one or more coupons/electronic FSIs appropriate for presentation with the homepage displayed to the consumer via the web browser. In embodiments, a standalone application may be configured to display the one or more coupons/electronic FSIs upon an initial accessing of the web browser, or upon the consumer accessing a particular retailer's website via the web browser.

Further still, a standalone application may be configured to operate in conjunction with location-based services, such as those disclosed in U.S. Pat. Nos. 7,693,752 and 7,231,357, both of which are incorporated herein by reference. For example, when a user/consumer device's resident map functionality, or, e.g., the Google Maps™ application is accessed or utilized, one or more coupons/electronic FSIs may be displayed to the consumer. Additionally, regardless of what application/use triggers the standalone application, one or more coupons/electronic FSIs may be presented to a consumer based upon location, such that if a consumer is near a given store, an electronic FSI targeted specifically for that store's products, or a loyalty card/frequent shopper card or account associated with the consumer may be displayed to the consumer. In embodiments, identification of a consumer and a consumer's location can be achieved via Wi-Fi positioning and/or GPS positioning, depending upon, e.g., the capabilities of the consumer device, the determination of a location via zip code determination or manual/automatic entry of a zip code, etc.

Presentation of the electronic FSI itself may be done in various formats and/or styles. For example, the electronic FSI may be presented in a portrait mode or a landscape mode, such as may be appropriate for the consumer device upon which the electronic FSI is rendered. If the consumer device is a standard telephone or smartphone, the electronic FSI may be presented in portrait form. However, if the consumer device is, e.g., a tablet PC, iPad™, or some other device that is utilized in a landscape orientation, or may switch between portrait and landscape modes, the electronic FSI may be presented in the appropriate orientation. Additionally, interacting with the electronic FSI may be accomplished based upon the capabilities of the consumer device upon which it is rendered. That is, interaction with the electronic FSI can be effectuated via, e.g., touch-screen control, joystick/mouse/trackpad/trackball control, hard keys, soft keys, etc.

Additionally, the presentation or rendering of the electronic FSI can be achieved in various ways. For example, if the electronic FSI is accessed or presented while a consumer is utilizing a web browser, the electronic FSI may be presented as simply another tab or page within the web browser. Alternatively, the electronic FSI may be presented as a new window or an overlay screen or in a sidebar.

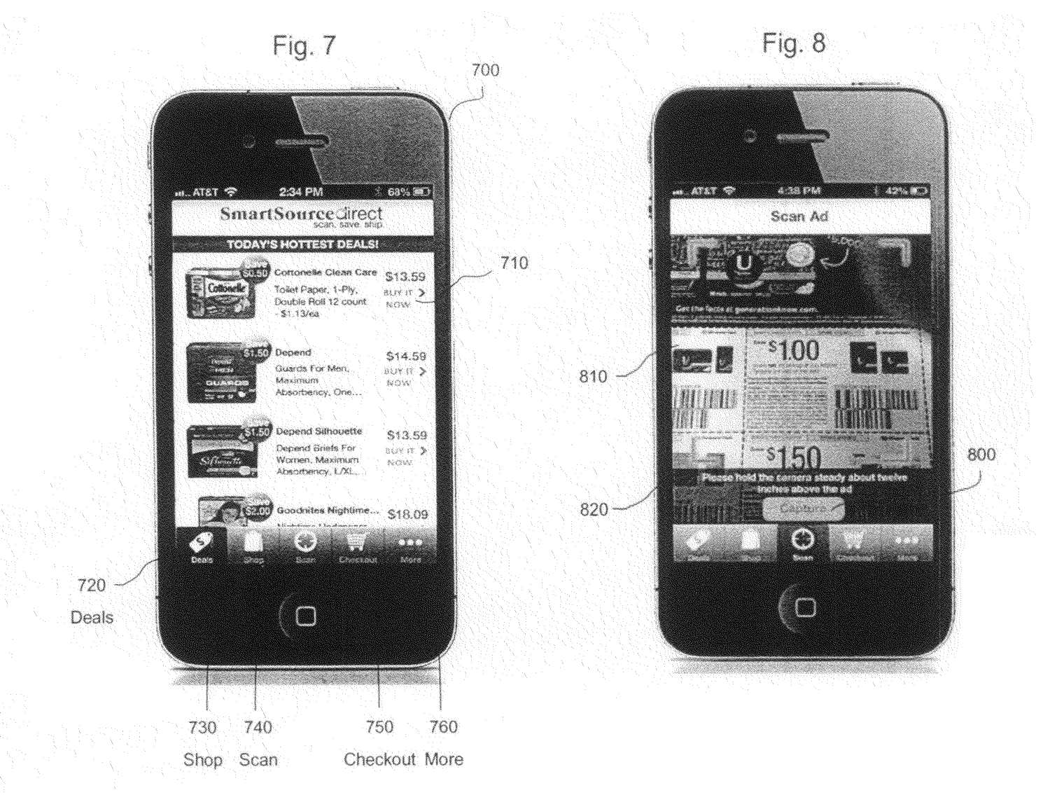

An implementation of a yet further embodiment of the invention relates to direct e-tailing through the use of smart phones and other consumer personal digital assistants (PDA's) configured with a software application to initiate, upon activation, a scanning or picture function and to transmit to a server via one or more networks, resulting image information illustrating all or a portion of the product or service or an advertised discount, e.g., a coupon, or of an advertisement or of a display or of an electronic document, such as for example, an electronic catalogue. Embodiments of this invention are shown in FIGS. 7-15.

Referring to FIG. 7, a representation of a smart phone 700 is illustrated with its display 710 illustrating embodiments with a Deals button 720, a Shop button 730, a Scan button 740, a Check-out button 750, and a More button 760 at the bottom of the display.

A click or other activation of the Deals button 720 will request the server to serve data for current deals being offered, as shown in FIG. 7, e.g., to link to one or more server pages showing current discount offers. When a signal is received that the indicator is clicked, the server may then serve, by the one or more computers, one or more server pages showing the current discount offers.

A click on the Scan 740 button will activate a scanning or photo operation in the smart phone or other PDA. In embodiments shown in FIG. 8, a capture screen 810 is illustrated with a capture button 800. In embodiments, text 820 may be displayed explaining how to scan or photograph a portion or all of image information from a product or service or from an advertised discount such as a coupon or from an advertisement or from a display or from one or more pages of an electronic document such as an electronic catalogue. For example, such text might read as follows: “Please hold the camera steady about twelve inches above the ad.”

In embodiments, the image information on a product or service or on an advertised discount or on an advertisement or on a display or on one or more pages of an electronic catalogue that are capable of being purchased through the server may contain a logo 1200, such as the “BUY NOW WITH SmartSource direct,” as shown in FIG. 12. This logo indicates that the product or service may be purchased thru this software application.

In embodiments, a click of the “Capture” 800 button causes a scan or photograph to be taken of a portion or all of image information from a product or service or from an advertised discount or from an advertisement or from a display or from one or more pages of an electronic document such as an electronic catalogue.

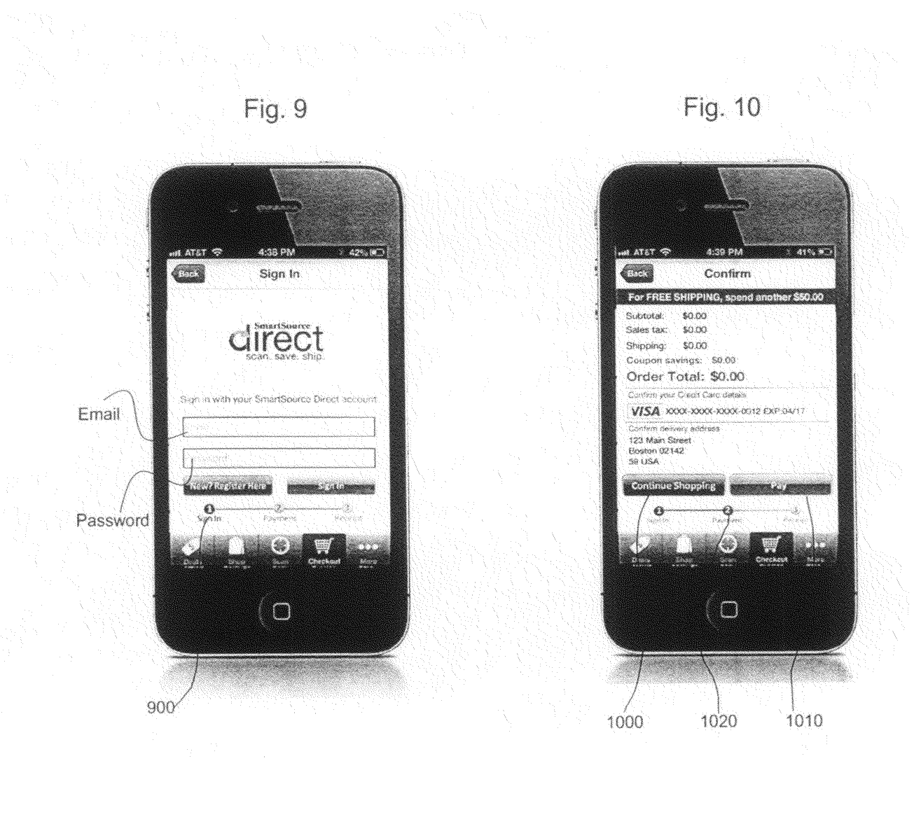

In embodiments, the software application may provide a screen with a Sign-in page for the consumer to put in his/her ID or email address and a password. Embodiments of a Sign-in screen are illustrated in FIG. 9.

In embodiments, the software application may also generate and display data indicating a progression in a purchase process. In embodiments, the progression may comprise a line (straight or otherwise) with at least nodes labeled Sign-in, Payment, and Receipt. In FIG. 9, the progression line illustrates that the Sign-in node 900 is highlighted indicating that the buy process is at the Sign-in stage of the process.

When the Sign-in button on FIG. 9 has been clicked and the sign-in has been successfully accomplished, the software application may couple the scanned or photographed image information or a portion thereof, with identification data for the consumer obtained from the consumer's smart phone or PDA, e.g., the consumer's ID and password or other identifying data, and transmit or otherwise send that data to the server.

FIG. 10 illustrates an embodiment of a Confirm display on the consumer's smart phone or PDA, with an identification of and a price for at least the product or service identified by the server from the image information. In embodiments, the price may be net of any advertised discount. In embodiments, the price net of the coupon discount may be obtained from the one or more databases. In embodiments, the price net of the coupon discount may be computed by subtracting the amount of the coupon discount from the price amount. In embodiments, an advertised discount savings may be displayed. In embodiments, a shipping charge may be displayed. In embodiments, an order total may be displayed. In embodiments, a tax associated with the purchase may be displayed. In embodiments, a delivery address may be displayed for confirmation. In embodiments, a credit card or other payment mechanism may be displayed. In embodiments, an additional purchase amount that is necessary in order to obtain free shipping is displayed.

In embodiments, FIG. 10 further provides a Continue Shopping button 1000, and a Pay button 1010. In embodiments, the buyer process progression line indicates that the progression is at a Payment node 1020.

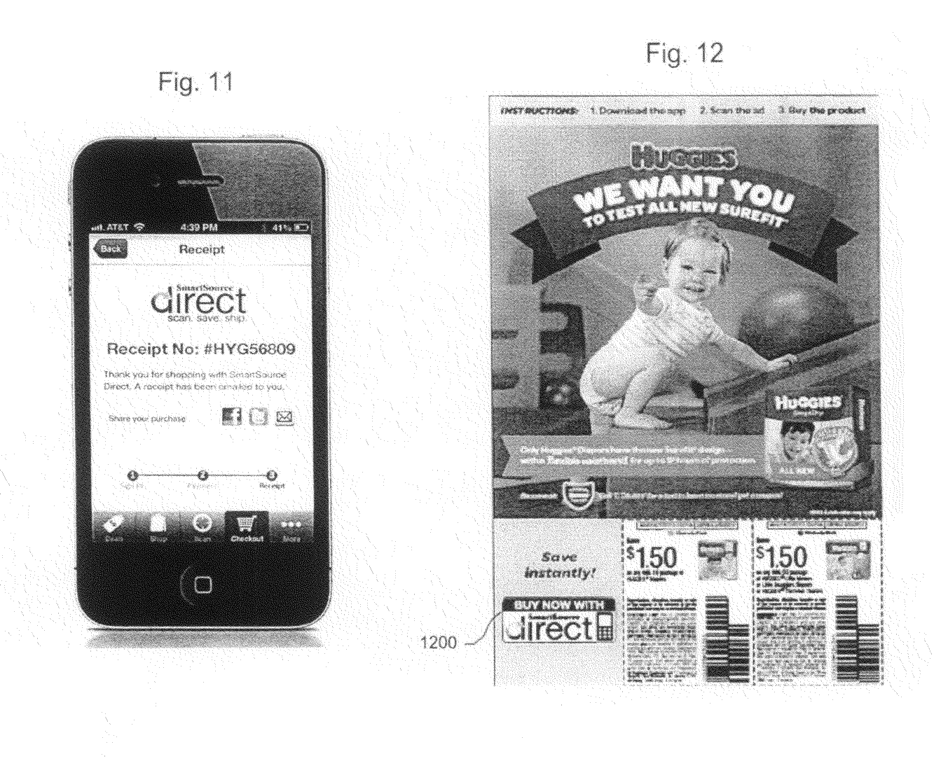

When the Pay button 1010 has been clicked, then the server serves a Receipt page, as illustrated in embodiments, in FIG. 11.

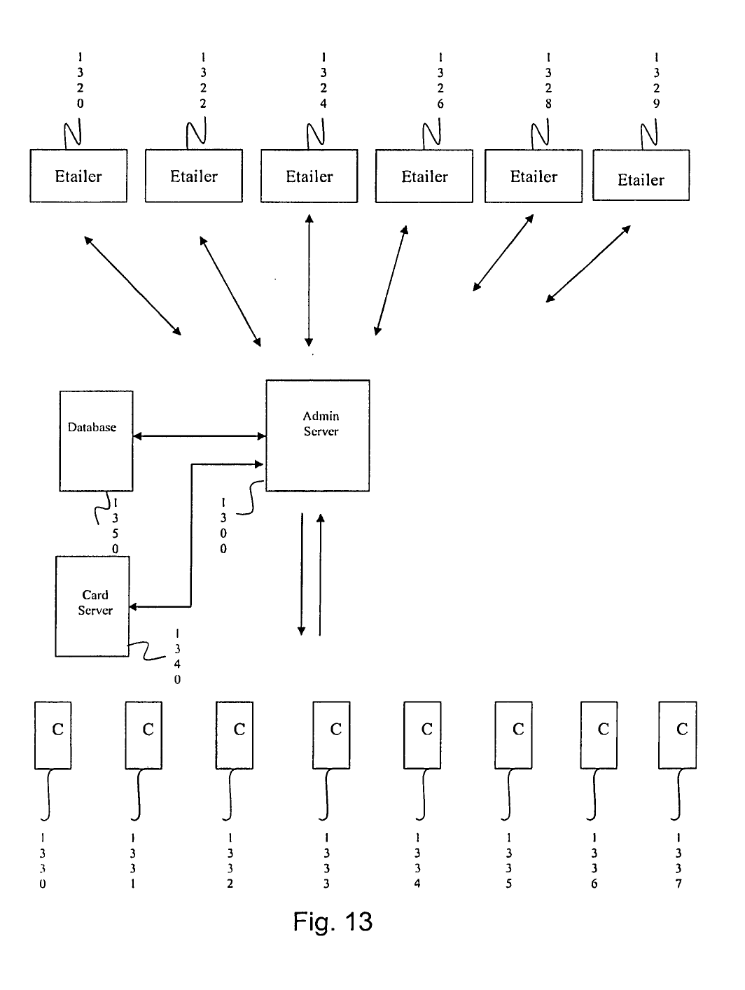

Referring now to FIG. 13, an embodiment of an overall configuration to implement the buy direct service is illustrated. A server 1300, implemented by one or more computers, is illustrated for performing processes of the invention and serving data to etailers and consumers. A set of one or more etailers 1320-1329 is shown communicating with the server 1300. These etailers have agreed to fulfill products or services purchased through the server 1300. In embodiments, a fulfillment agreement and/or fulfillment agreement terms may be stored in one or more databases 1350. Fulfillment data may be retrieved from the one or more databases 1350 when a purchase of a product or service associated with the etailer is made. The one or more databases 1350 may also store product and/or service image information and consumer identification and demographic data. A set of consumers 1330-1337 is also illustrated for communicating with the server to be served data and to purchase products and/or services via the server 1300. A card server or other payment service is represented by block 1340 for facilitating payment for the products and/or services purchased through the server 1300.

In embodiments, the server 1300 will operate to receive, from the consumer, the transmitted image information and consumer identification data. The server will identify the consumer by comparing the identification data of the consumer to consumer identification data in the one or more databases 1350. The server will compare the transmitted image information to one or more portions of the stored image information to determine if there is an image match. When there is a match to one or more portions of the stored image information in the one or more databases 1350, then the server will: retrieve, data for the entity agreeing to fulfill the product or service at the price based at least in part on the advertised discount, and initiate a product or service fulfillment process.

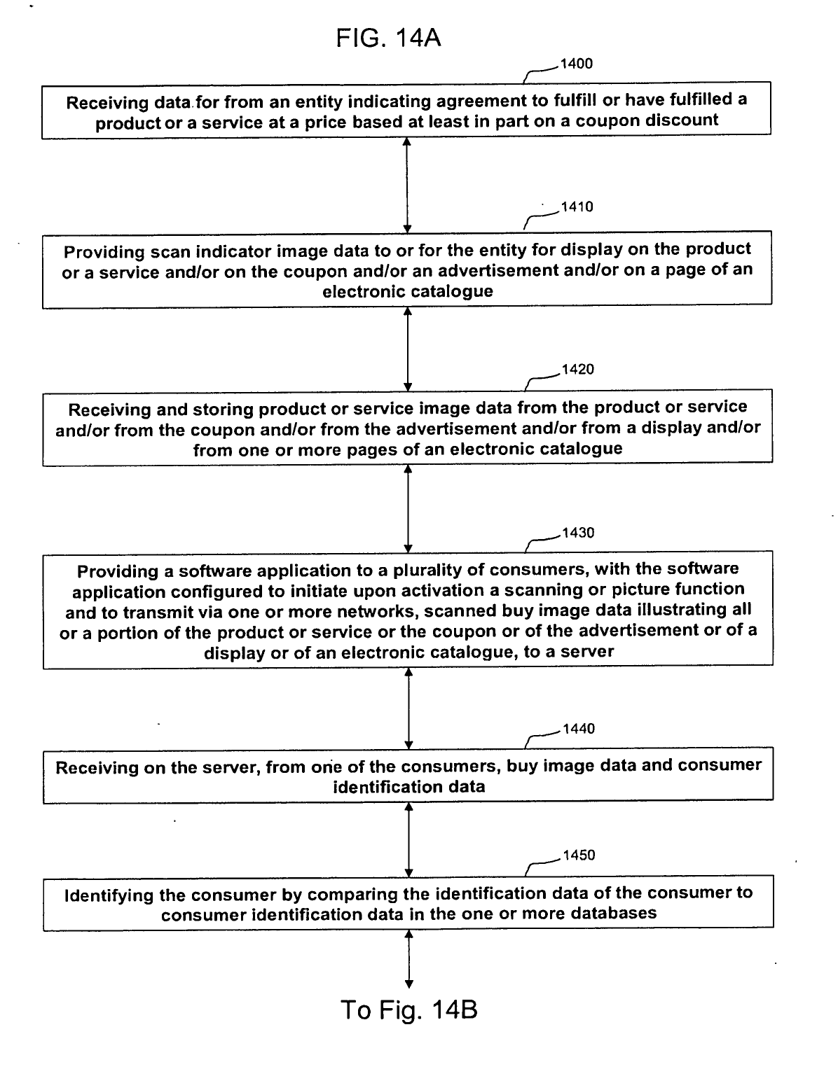

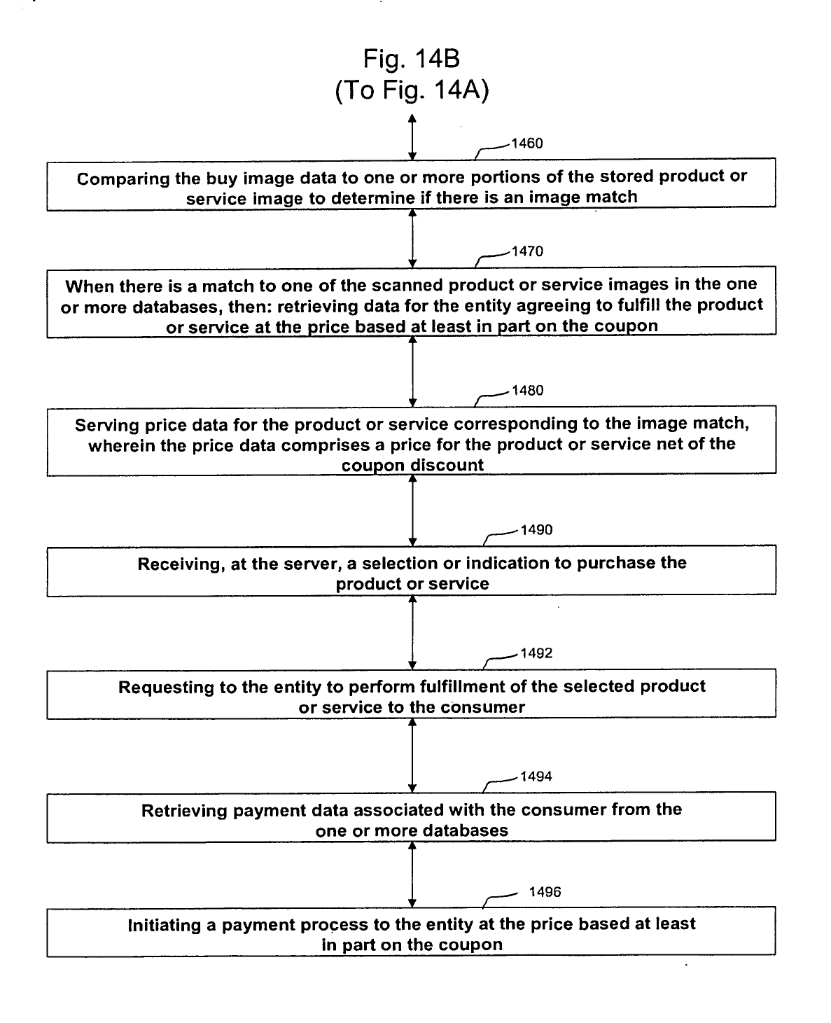

Referring now to FIG. 14, an embodiment of a process consistent with the invention is illustrated. Block 1400 represents an operation of receiving or obtaining or having receiving, into one or more databases by one or more computers, for each of a plurality of entities, respective agreement data for the respective entity indicating agreement to fulfill or have fulfilled a respective product or service at a price based at least in part on an advertised discount. Note that in embodiments, this entity fulfillment data may be received electronically, or may be received by telephone or facsimile and then scanned or keyed into the one or more databases.

Block 1410 represents an operation of providing to each of the respective entities scan indicator image information to or for the entity by the one or more computers, for display on the product or a service and/or on the advertised discount and/or an advertisement, and/or on a display, and/or on a page of an electronic documents such as an electronic catalogue. An embodiment of such a scan indicator image information is the logo 1200 in FIG. 12. In embodiments, electronic data for this logo may be transmitted or delivered or otherwise provided to the respective etailer for inclusion on products or services and/or on advertised discounts and/or on advertisements and/or on displays and/or on one or more pages of an electronic document. In embodiments, the electronic data for this logo may be provided for insertion by the one or more computers into advertised discounts and/or on advertisements and/or displays and/or on one or more pages of an electronic document to be served by the server 1300. In embodiments, this operation is optional and may be performed for none of the entities, or only some of the entities, or all of the entities.

Block 1420 represents an operation of receiving and storing for each of the respective entities, into the one or more databases 1350 by the one or more computers, image information from their respective product or service or from their advertised discount or from their advertisement or from their display or from one or more pages of their electronic document. This image information may be used in embodiments by the one or more computers 1300 in a comparison process. For example, such image information may comprise all or a portion of the image shown in FIG. 12.

Block 1430 represents an operation of providing or facilitating provision, by the one or more computers, of a software application to a plurality of consumers, with the software application configured to initiate upon activation a scanning or picture function and to transmit via one or more networks, resulting image information illustrating all or a portion of a product or service or an advertised discount or a display of an advertisement or a display or of an electronic catalogue or other electronic document, to the server 1300 configured by the one or more computers. In embodiments, the software application may be downloadable from the server or from another server. In embodiments, the software application may be transmitted to consumers. In embodiments, the software application may be contained as program code on a disk or other media that may be mailed or otherwise provided to consumers.

Block 1440 represents an operation of receiving on the server, from one of the consumers, transmitted image information and consumer identification data.

Block 1450 represents an operation of identifying the consumer, by the one or more computers, by comparing the identification data of the consumer to consumer identification data held in the one or more databases 1350.

Block 1460 represents an operation of comparing, by the one or more computers 1300, the transmitted image information to one or more portions of the stored image information to determine if there is an image match.

Block 1470 represents an operation of: when a match of the transmitted image information to one or more portions of the scanned image information in the one or more databases 1350 is determined, then retrieving, by the one or more computers 1300, data for the respective entity corresponding to the product or service in the one or more databases 1350 that has agreed to fulfill the product or service at the price based at least in part on the advertised discount. Note that in embodiments, it is not required that the scan indicator image information be in the received scanned image information in order to have a match.

Block 1480 represents an operation of serving, by the one or more computers, price data for the respective product or service corresponding to the image match. In embodiments, the price data may comprise a price for the respective product or service net of the advertised discount. In embodiments, this price net of the advertised discount may be retrieved from the one or more databases 1350. In embodiments, this price net of the advertised discount may be computed by subtracting the advertised discount from an original price.

Block 1490 represents an operation of receiving, at the server, a selection or indication to purchase the respective identified product or service.

Block 1492 represents an operation of requesting to the entity, by the one or more computers, to perform fulfillment of the selected product or service to the consumer.

Block 1494 represents an operation of retrieving, by the one or more computers, payment data associated with the consumer from the one or more databases. The operation may be accomplished, in embodiments, by transmitting a message to the entity via the one or more computers and one or more electronic networks.

Block 1496 represents an operation of initiating, by the one or more computers, a payment process to the entity at the price based at least in part on the advertised discount.

In embodiments, the requesting fulfillment step may further comprise providing in the request a consumer fulfillment address and/or a transfer of funds to the entity.

In embodiments, the method may further comprise causing, by the one or more computers, transfer of funds to the entity for fulfillment of the product or service.

In embodiments, the serving step may further comprise serving an identification of and a price for at least one other product or service related to the product or service selected.

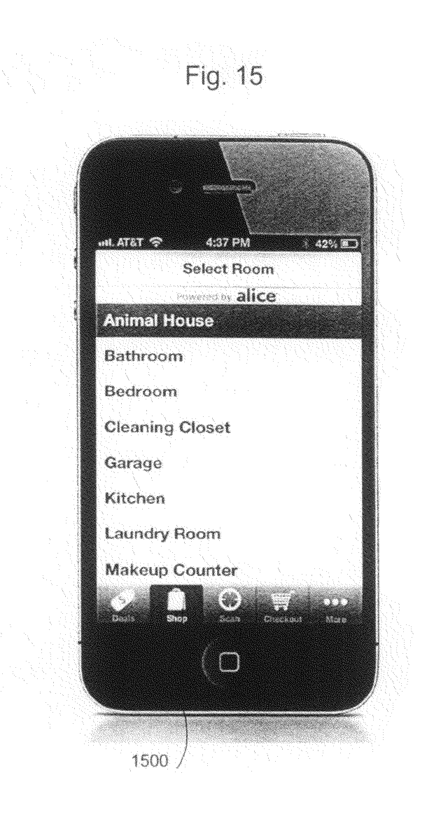

In embodiments, the software application may be configured to provide an icon or button to trigger shopping for other products or services. This embodiment is illustrated by clicking the Shop button 1500 in FIG. 15.

In embodiments, the serving of the Confirm display, as illustrated in FIG. 10, may further comprise the operations of subtracting, by the one or more computers, the price of the product or service from a predetermined free shipping amount to obtain a difference amount, and generating, by the one or more computers, display data indicating an additional purchase amount based on the difference amount that is needed in order to qualify for free shipping.

In embodiments, the serving of the Confirm display, as illustrated in FIG. 10, may further comprise including the advertised discount data on the display.

In embodiments, the process may further comprise correlating, by the one or more computers, purchase data for the product or service with one or more demographic data elements, e.g., age, location, gender, income, to name a few, of the consumer, determining, by the one or more computers, other different consumers that match one or more of these demographic elements, and communicating electronically an offer, by the one or more computers, to a different one of the consumers that match one or more demographic elements that are the same as the consumer that purchased the respective product or service. In embodiments, the offer may be for the same product or service or for a different product or service offering related to the respective product or service.

In embodiments, the process may further comprise categorizing products and/or services, by the one or more computers, into one or more cyclical categories and a non-cyclical category. The process may further comprise retrieving a respective purchase cycle for the respective product or service from one or more databases 1350, and associating, by the one or more computers, a respective purchase cycle to each of multiple of the respective products and/or services that are categorized in a cyclical category. For example, there may be data in the one or more databases that families with new babies purchase diapers every two weeks for a two year period. This information may be used to categorize the product diapers in the cyclical category with a purchase cycle data of two weeks, over the course of two years. In embodiments, the process may further comprise communicating electronically an offer, by the one or more computers, to a consumer that has purchased a respective product or service in the past, the offer for the same product or service or for a different product or service offering related to the respective product or service, where the offer may be communicated at a time based at least in part on the purchase cycle associated with the respective product or service. Thus, the system may present the consumer with future purchase opportunities or send the consumer just-in-time offers on such cyclical products, based at least in part on such prior purchases.

In embodiment, as noted for FIG. 7, the software application may also contain a Shop button 730, which provides a full catalog for one each of one or more etailers. Some of the items in the catalogue may be advertised discounted items, and some of the items may be non-couponed items.

In embodiment, as noted for FIG. 7, the software application may also contain a More button 770, which provides miscellaneous items such as Contact Us, and Terms of Use.

Various embodiments are described herein with reference to drawings. These drawings illustrate certain details of specific embodiments that implement the systems and methods and programs of the present invention. However, describing the invention with drawings should not be construed as imposing on the invention any limitations that may be present in the drawings. Various embodiments contemplate methods, systems and program products on any machine-readable storage media for accomplishing its operations. The embodiments of the present invention may be implemented using an existing computer processor, or by a special purpose computer processor incorporated for this or another purpose or by a hardwired system.

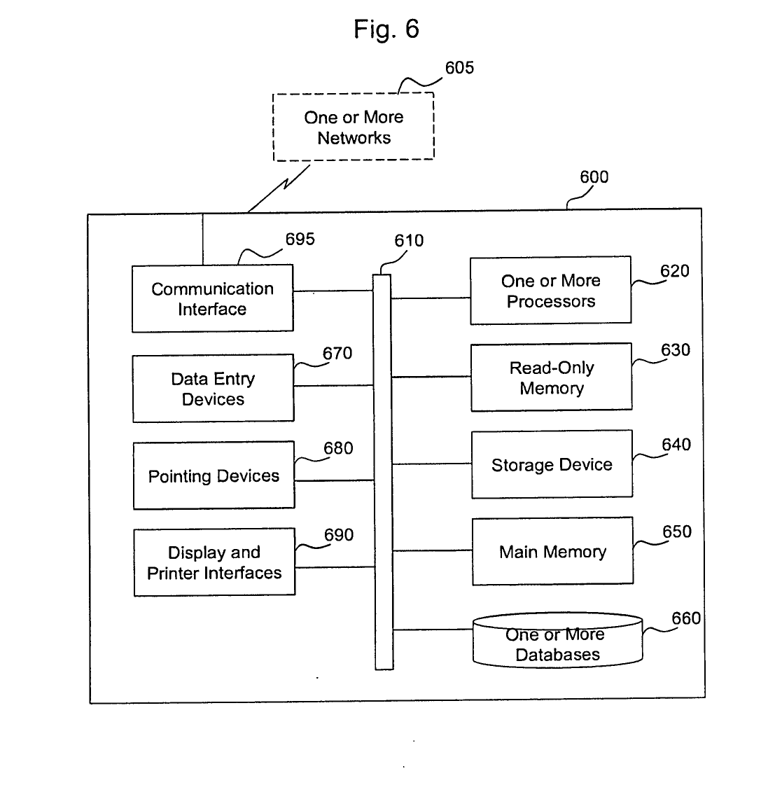

FIG. 6 is a block diagram illustrating an embodiment of a computer system 100 that may be used for implementations, generally designated by reference number 600 in FIG. 6. In embodiments, the system 600 may be communicatively coupled to one or more networks 605 via a communication interface 695. The one or more networks 605 may represent a generic network, which may correspond to a local area network (LAN), a wireless LAN, an Ethernet LAN, a token ring LAN, a wide area network (WAN), the Internet, a proprietary network, an intranet, a telephone network, a wireless network, to name a few, and any combination thereof. Depending on the nature of the network employed for a particular application, the communication interface 695 may be implemented accordingly. The network 605 serves the purpose of delivering information between connected parties. Note that the computing and/or storage of data may be remote, e.g., so-called cloud computing and/or storage.

The system 600 may comprise, in embodiments, a computing platform for performing, controlling, and/or initiating computer-implemented operations, for example, via a server and the one or more networks 605. The computer platform may comprise system computers and other party computers. The system 600 may include, one or more personal computers, workstations, notebook computers, servers, mobile computing devices, handheld devices, multi-processor systems, networked personal computers, minicomputers, mainframe computers, personal data assistants, Internet appliances (e.g., a computer with minimal memory, disk storage and processing power designed to connect to a network, especially the Internet, etc.), or controllers, to name a few. The system 600 may operate under the control of computer-executable instructions to carry out the process steps described herein. Computer-executable instructions comprise, for example, instructions and data which cause a general or special purpose computer system or processing device to perform a certain function or group of functions. Computer software for the system 600 may comprise, in embodiments, a set of software objects and/or program elements comprising computer-executable instructions collectively having the ability to execute a thread or logical chain of process steps in a single processor, or independently in a plurality of processors that may be distributed, while permitting a flow of data inputs/outputs between components and systems.

The system 600 may comprise, in embodiments, a bus 610 or other communication component that couples the various system elements 620-695, and is configured to communicate information between the various system elements 620-695.

As shown in FIG. 6, the one or more computers may comprise one or more computer processors 620 coupled with the bus 610 and configured to process and handle information and execute instructions. In embodiments, the system 600 may comprise a main memory 650, such as a Random Access Memory (RAM) or other dynamic storage device, coupled to the bus 600, for storing information and instructions to be executed by the one or more processors 620. The main memory 650 also may be used for storing temporary variables or other inter intermediate information during execution of instructions by the one or more processors 620.

In embodiments, the system 600 may include a Read-Only Memory (ROM) 630 or other static storage device (e.g., EPROM, EAROM, EEPROM, PROM, flash, and the like) coupled to the bus 610 for storing static information and instructions for the one or more processors 620. In embodiments, a storage device 640, such as a magnetic disk, semiconductor memory, or optical disk, such as a CD-ROM or other optical media may be provided and coupled to the bus 610 for storing information and instructions.

In embodiments, in addition to the ROM 630, one or more databases 660 may be coupled to the bus 610 for storing static information and software instructions. Information stored in or maintained in the database 660 may be provided in conformance with a database system format such as, but not limited to, the Structured Query Language (SQL) format. Database query and access instructions, for example, in the form of one or more scripts, may be used which, when executed by a processor such as the processor 620, serve to access, store and retrieve data maintained in the database 660 according to the instructions contained in the script.

Furthermore, the system 600 may comprise application software instructions which may implement a user interface portion for generating interactive pages or display screens by which a user may provide data to and receive information from the system 600 and the database 660 using a human-machine interface. Interactive pages may include user dialog boxes for accepting user entered information. In particular, the human-machine interface may comprise a Graphical User Interface (GUI) portion for prompting the user to enter data by providing an interactive dialog box or message box instructing the user to enter particular data, or to select from among a multitude of options provided using a pull-down menu. A user may interact with the system 600 via the graphical user interface by using a pointing device and/or data entry device. The GUI portion may place the output of the system 600 in a format for presentation to a system user via the display. In at least one embodiment, the GUI may be implemented as a sequence of Java instructions. In embodiments, the system 600 may include a voice interface 685 to allow user control by voice command.

In embodiments, a data entry device 670, including alphanumeric and other keys, or a pointing device such as a mouse or trackball, or a scanner, to name a few, may be coupled to the bus 610 for communicating information and command selections to the processor 620. The data entry device 670 may be coupled to the bus 610 via an interface (not shown), wherein the interface may be, for example, a serial port, an RS-232 port, or the like. In addition, the interface may be a wireless interface and provide connection-less communication via, for example, Bluetooth communication.

The system 600 may be coupled via the bus 610 to a display or printer 690 for outputting information to a system user. In addition, a system user may use the display (e.g., touch screen) or printer (e.g., scanner) to provide information to the system 600.

In embodiments, the various program operations as described herein may be provided by the system 600 in response to the one or more processors 620 executing one or more sequences of computer-readable instructions contained in the main memory 650. Such instructions may be read into the main memory 650 from another computer-readable medium, such as the ROM 630, the storage device 640, or the database 660. Execution of the sequences of instructions contained in the main memory 650 may cause the one or more processors 620 to perform the process steps described herein. It should be appreciated that an embodiment of the system 600 may perform fewer or additional processes as compared to those described herein. As noted, the one or more processors 620 may be arranged in a multi-processing arrangement. Alternatively, hard-wired circuitry may be used in place of or in combination with software instructions to implement the invention. Thus, embodiments of the invention are not limited to any specific combination of hardware circuitry and software.

Embodiments include program products comprising machine-readable media with machine-executable instructions or data structures stored thereon. Such machine-readable media may be any available storage media which may be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other storage medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention have been described in the general context of method steps which may be implemented in embodiments by a program product including machine-executable instructions, such as program code, for example in the form of program modules executed by machines in networked environments. Generally, program modules include routines, programs, objects, components, data structures, etc., that perform particular tasks or implement particular data types. Multi-threaded applications may be used, for example, based on Java or C++. Machine-executable instructions, associated data structures, and program modules represent examples of program code for executing steps of the methods disclosed herein. The particular sequence of such executable instructions or associated data structures represent examples of corresponding acts for implementing the functions described in such steps.

As noted, embodiments of the present invention may be practiced with one or multiple computers in a networked environment using logical connections to one or more remote computers (including mobile devices) having processors. Embodiments of the invention may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

As previously noted, in embodiments the system 600 also may comprise a communication interface 695 coupled to the bus 610 for providing one-way, two-way or multi-way data communication with the network 605, or directly with other devices. In embodiments, the communication interface 695 may comprise a modem, a transceiver Integrated Services Digital Network (ISDN) card, a WAN card, an Ethernet interface, or the like, to provide a data communication connection to a corresponding type of communication medium. As another example, the communication interface 695 may comprise a LAN card to provide a data communication connection to a compatible LAN. Wireless links may also be implemented. In such wireless links, communication interface 695 may communicate with a base station communicatively coupled to a network server. In any such implementation, the communication interface 695 sends and receives electrical, electromagnetic, radio, infrared, laser, or optical signals that carry digital data streams representing various types of information. Any combination of the above interfaces may also be implemented.

In embodiments, the communication interface 695 may be communicatively coupled to a web server configured to generate and output web content that is suitable for display using a web browser at a computing device. In embodiments, the server may generate and transmit requested information through the communication interface 695 to a requesting terminal via Hypertext Transfer Markup Language (HTML) formatted pages, eXtensible Markup Language (XML) formatted pages, or the like, which may be provided as World Wide Web pages that may enable navigation by hyperlinks. The server program may be used to receive commands and data from the clients' terminals, access and process data from various sources, and output computer-executable instructions and data using the network 605.

In embodiments, the web server, in embodiments, may correspond to a secure web application server operating behind a web server program that a service provider employs to run one or more web based application programs to carry out the methods described above in a secure fashion. Such a secure web application server may be configured to execute one or more web based application programs, respond to commands and data received from the clients (via a web page supported by the web server), and provide data and results to the clients. The web server and the web application server may be implemented using a single computing platform. Alternatively, it may be implemented using multiple separate and distributed computing platforms.

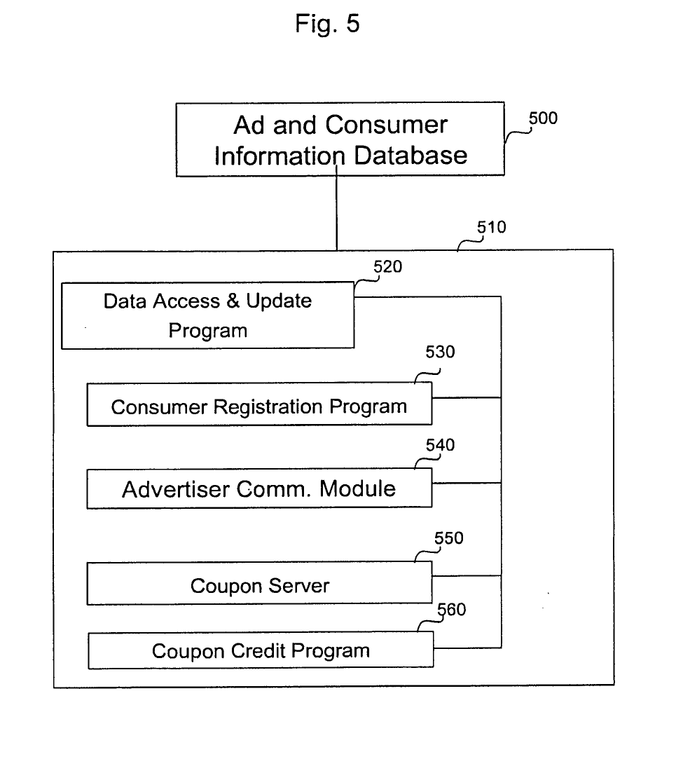

Referring to FIG. 5, the one or more computers of the system may, in embodiments, be configured with the illustrated components and/or modules stored separately or in combination. In the embodiment shown in FIG. 5, the one or more computers are configured, with data access and update program code 520 for accessing data and for updating the one or more databases 500. FIG. 5 further comprises consumer registration module 530 for obtaining registration data such as consumer identification information, payment information, e.g., payment card information, and one or more fulfillment addresses. FIG. 5 further comprises an advertiser communication module 540 for communicating with an advertiser regarding selecting/obtaining data on a coupon to be associated to an advertised product and/or service, a pre-selection of one or more ecommerce partners 120-129, who will be included in an array of etailers for the respective coupon offering, and other information. FIG. 5 further comprises program code 550 for implementing a coupon server. FIG. 5 further comprises program code 560 for crediting and/or initiating crediting of the coupon to the payment account or another account designated by the consumer. Various other program code may also be included such as a reports program module, to name a few.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations. It should also be noted that the phrase “a plurality” is intended to mean more than one, and is not intended to refer to any previous recitation of the word “plurality,” unless preceded by the word “the.”

All components, modes of communication, and/or processes described heretofore are interchangeable and combinable with similar components, modes of communication, and/or processes disclosed elsewhere in the specification, unless an express indication is made to the contrary. It is intended that any structure or step of an embodiment disclosed herein may be combined with other structure and or method embodiments to form an embodiment with this added element or step.

The foregoing description of embodiments of the invention has been presented for purposes of illustration and description. It is not intended to be exhaustive or to limit the invention to the precise form disclosed. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangements of the preferred and other exemplary embodiments without departing from the spirit of the present invention.

1. A method, comprising:
receiving or obtaining or having received or obtained, into one or more databases by one or more computers, for each of a plurality of entities, respective agreement data for the respective entity indicating agreement to fulfill or have fulfilled a respective product or a service at a price based at least in part on an advertised discount;
for each of the plurality of the entities,
providing scan indicator image information to or for the entity by one or more computers, for display on the product or a service and/or on the advertised discount and/or an advertisement, and/or on a display, and/or on a page of an electronic document;
receiving and storing, into the one or more databases by one or more computers, image information from their product or service or from their advertised discount or from their advertisement or from their display or from one or more pages of their electronic document;
providing or facilitating provision, by the one or more computers, a software application to a plurality of consumers, with the software application configured to initiate upon activation a scanning or picture function and to transmit via one or more networks, resulting image information illustrating all or a portion of one of the products or services or one of the advertised discounts or one of the advertisements or a display or one of the electronic documents, to a server configured by the one or more computers;
receiving on the server, from one of the consumers, the transmitted image information and consumer identification data;
identifying the consumer, by the one or more computers, by comparing the identification data of the consumer to consumer identification data in the one or more databases;
comparing, by the one or more computers, the transmitted image information to one or more portions of the stored image information to determine if there is an image match;
when there is a match to one or more portions of the scanned image information in the one or more databases, then:
retrieving, by the one or more computers, data for the respective entity agreeing to fulfill the product or service corresponding to the image match at the price based at least in part on the advertised discount;
serving, by the one or more computers, price data for the respective product or service corresponding to the image match, wherein the price data comprises a price for the respective product or service net of the advertised discount;
receiving, at the server, a selection or indication to purchase the respective product or service;
requesting to the entity, by the one or more computers, to perform fulfillment of the selected product or service to the consumer;
retrieving, by the one or more computers, payment data associated with the consumer from the one or more databases;
and
initiating, by the one or more computers, a payment process to the entity at the price based at least in part on the advertised discount.

2. The method as defined in claim 1, further comprising causing, by the one or more computers, transfer of funds to the entity for fulfillment of the respective product or service.

3. The method as defined in claim 1, wherein the requesting fulfillment step further comprises providing a consumer fulfillment address and a transfer of funds to the respective entity in the request.

4. The method as defined in claim 1, wherein the serving step further comprises serving an identification of and a price for at least one other product or service related to the product or service selected.

5. The method as defined in claim 1, wherein the software application is configured to generate display data indicating a progression in a purchase process.

6. The method as defined in claim 5, wherein the display data provides a line with at least nodes labeled sign-in, payment, and receipt.

7. The method as defined in claim 1, wherein the software application is configured to provide an icon or button to trigger shopping for other products or services.

8. The method as defined in claim 1, further comprising:
subtracting, by the one or more computers, the price from a predetermined free shipping amount to obtain a difference amount; and
generating, by the one or more computers, display data indicating an additional purchase amount based on the difference amount that is needed in order to qualify for free shipping.

9. The method as defined in claim 1, wherein the advertised discount data is included with the price data.

10. The method as defined in claim 1, further comprising:
correlating, by the one or more computers, purchase data for the product or service with one or more demographic data elements of the consumer;
determining, by the one or more computers, different consumers that match one or more of the demographic elements; and
communicating electronically an offer, by the one or more computers, to a different one of the consumers that match the one or more demographic elements that are the same as the consumer that purchased the respective product or service, the offer being for the same product or service or for a different product or service offering related to the respective product or service.

11. The method as defined in claim 1, further comprising:
categorizing products and/or services, by the one or more computers, into a cyclical category and a non-cyclical category;
associating, by the one or more computers, a respective purchase cycle to each of multiple of the respective products and/or services that are categorized in the cyclical category; and
communicating electronically an offer, by the one or more computers, to a consumer that has purchased a respective product or service in the past, the offer for the same product or service or for a different product or service offering related to the respective product or service, wherein the offer is communicated at a time based at least in part on the purchase cycle associated with the respective product or service.

12. The method as defined in claim 1,
wherein the software application is configured to cause display of an indicator to link to one or more server pages showing current discount offers, and
further comprising serving, by the one or more computers, one or more server pages showing the current discount offers.

13. A system, comprising:
one or more computers, with memory storing computer-readable program code to perform, when executed, the steps:
receiving or obtaining or having received or obtained, into one or more databases by the one or more computers, data for an entity indicating agreement to fulfill or have fulfilled a product or a service at a price based at least in part on an advertised discount;
providing scan indicator image information to or for the entity by one or more computers, for display on the product or a service and/or on the advertised discount and/or an advertisement, and/or on a display, and/or on a page of an electronic document;
receiving and storing, into the one or more databases by one or more computers, image information from the product or service or from the advertised discount or from the advertisement or from a display or from one or more pages of an electronic document;
providing or facilitating provision, by the one or more computers, a software application to a plurality of consumers, with the software application configured to initiate upon activation a scanning or picture function and to transmit via one or more networks, resulting image information illustrating all or a portion of the product or service or the advertised discount or of the advertisement or of an electronic document, to a server configured by the one or more computers;
receiving on the server, from one of the consumers, the transmitted image information and consumer identification data;
identifying the consumer, by the one or more computers, by comparing the identification data of the consumer to consumer identification data in the one or more databases;
comparing, by the one or more computers, the transmitted image information to one or more portions of the stored image information to determine if there is an image match;
when there is a match to one of the scanned image informations in the one or more databases, then:
retrieving, by the one or more computers, data for the entity agreeing to fulfill the product or service at the price based at least in part on the advertised discount;
serving, by the one or more computers, price data for the product or service corresponding to the image match, wherein the price data comprises a price for the product or service net of the advertised discount;
receiving, at the server, a selection or indication to purchase the product or service;
requesting to the entity, by the one or more computers, to perform fulfillment of the selected product or service to the consumer;
retrieving, by the one or more computers, payment data associated with the consumer from the one or more databases;
and
initiating, by the one or more computers, a payment process to the entity at the price based at least in part on the advertised discount.

14. The system as defined in claim 13, wherein the memory stores program code to perform, when executed, the step of causing, by the one or more computers, transfer of funds to the respective entity for fulfillment of the product or service.

15. The system as defined in claim 13, wherein the requesting fulfillment step further comprises providing a consumer fulfillment address and a transfer of funds to the entity in the request.

16. The system as defined in claim 13, wherein the serving step further comprises serving an identification of and a price for at least one other product or service related to the product or service selected.

17. The system as defined in claim 13, wherein the software application is configured to generate display data indicating a progression in a purchase process.

18. The system as defined in claim 13, wherein the memory stores program code to perform, when executed, the steps:
subtracting, by the one or more computers, the price from a predetermined free shipping amount to obtain a difference amount; and
generating, by the one or more computers, display data indicating an additional purchase amount based on the difference amount that is needed in order to qualify for free shipping.

19. The system as defined in claim 13, wherein the memory stores program code to perform, when executed, the steps:
correlating, by the one or more computers, purchase data for the product or service with one or more demographic data elements of the consumer;
determining, by the one or more computers, different consumers that match one or more of the demographic elements; and
communicating electronically an offer, by the one or more computers, to a different one of the consumers that match the one or more demographic elements that are the same as the consumer that purchased the respective product or service, the offer being for the same product or service or for a different product or service offering related to the respective product or service.

20. The system as defined in claim 13, wherein the memory stores program code to perform, when executed, the steps:
categorizing products and/or services, by the one or more computers, into a cyclical category and a non-cyclical category;
associating, by the one or more computers, a respective purchase cycle to each of multiple of the respective products and/or services that are categorized in the cyclical category; and
communicating electronically an offer, by the one or more computers, to a consumer that has purchased a respective product or service in the past, the offer for the same product or service or for a different product or service offering related to the respective product or service, wherein the offer is communicated at a time based at least in part on the purchase cycle associated with the respective product or service.
